(19) United States
(12) Patent Application Publication
(10) Pub. No.: US 2002/0089744 A1
(43) Pub. Date: Jul. 11, 2002

(54) Masked split image stereoscopic system and method

(76) Inventor: Kenneth J. Myers, Dobbs Ferry, NY (US)

Correspondence Address: BACON & THOMAS, PLLC, 625 SLATERS LANE, FOURTH FLOOR, ALEXANDRIA, VA, 22314

(21) Appl. No.: 10/054,896

(22) Filed: Jan. 25, 2002

Related U.S. Application Data
(63) Continuation-in-part of application No. 09/538,731, filed on Mar. 30, 2000.
Application No. 09/538,731 is a continuation-in-part of application No. 09/481,942, filed on Jan. 13, 2000.

(51) Int. Cl. G02B 27/22; G02B 27/26

(52) U.S. Cl. 359/465; 359/463

(57) ABSTRACT

A stereoscopic imaging system and method involves transmission of the left and right eye portions of the stereoscopic image as separate images, the separate images being interlaced following display and polarization. The images may conveniently be interlaced or combined using a microprism sheet, the left and right eye portions of the interlaced image being distinguishable by polarized lenses in order to obtain a stereoscopic effect.

This application is a continuation-in-part of U.S. patent application Ser. No. 09/538,731, filed Mar. 30, 2000, which is a continuation-in-part of U.S. patent application Ser. No. 09/481,942, filed Jan. 1-3, 2000, and incorporated herein by reference.

### BACKGROUND OF THE INVENTION

1. Field of the Invention

The invention relates to a system and method of stereoscopic imaging, and in particular to a stereoscopic system and method in which the left and right eye images are separately displayed before interlacing so that they can be more easily polarized. This is made possible by using a microprism sheet to interlace the separate oppositely polarized images.

A system including polarizers and an image combining microprism sheet is also disclosed in U.S. Pat. No. 4,588,259 (Sheiman). However, although the Sheiman patent discloses use of what is effectively a microprism image combiner similar that disclosed in copending U.S. patent application Ser. Nos. 09/481,942 and 09/538,731, permitting the use of a simple sheet polarizer for each side-by-side image and thereby eliminating the need for switching or other much more complex image discriminating schemes, the system disclosed by Sheiman is essentially unworkable due to the ghost images. The present invention provides a simple structure for that solves the ghost image problem, and that in general provides an especially practical and convenient way to implement the invention.

The invention also relates to a stereoscopic display attachment that can be retro-fitted onto a television or computer monitor for converting side-by-side images into stereoscopic images according to the principles described in U.S. patent application Ser. Nos. 09/481,942 and 09/538,731.

2. Description of Related Art

The present invention provides various improvements on the concept of using microprism sheets to interlace images in a stereoscopic imaging system, as disclosed in copending U.S. patent application Ser. Nos. 09/481,942 and 09/538,731, incorporated by reference herein. The improvements include the provision of a mask to eliminate the ghosting to which systems of the type disclosed in the Sheiman patent are subject, and the provision of a structure that enables retrofitting of an ordinary television or computer monitor to enable stereoscopic viewing according to the principles of the invention.

The invention offers a solution to a number of technical difficulties that have heretofore limited stereoscopic or “3D” devices to unappealing novelty items, implemented in the form of cardboard glasses with blue and red cellophane lenses distributed at fast food restaurants. In particular, the invention makes it possible to use polarizers and polarizing filters rather than color filters to distinguish between left and right eye images by providing a simple way of combining or interlacing the images following polarization, without the need for beam splitters or other sophisticated optical or opto-electronic systems, and without the problem of ghosting that has plagued previous image-interlacing stereoscopic systems.

The basic principles of stereoscopic imaging are well-known. Human vision is stereoscopic because each eye views the same scene from a different angle. The two separate images are combined by the brain to create a stereoscopic effect. In order to recreate the stereoscopic appearance of a scene on a flat screen, the scene must be captured by two cameras, one representing what a left eye would normally see, and one representing what a right eye would normally see. The left and right eye images are then interlaced so as to originate from the same location. A stereoscopic or three-dimensional image is obtained when each eye sees only the corresponding left and right eye portions of the interlaced image.

There are two ways to optically modify the left and right eye portions of the interlaced images so that the left eye sees only the left eye portion of the interlaced image and the right eye sees only the right eye portion of the interlaced image. One way, illustrated in FIG. 1, is to color the left and right eye portions of the interlaced image 100 and to use color filters 101,102 to ensure that the left and right eyes see only the correspondingly colored portions of the interlaced image. The other way to modify the left and right eye images so that each eye will only see appropriate portions of the interlaced image is to polarize the left and right eye images in opposite directions, and to use oppositely polarized lenses to view the oppositely polarized portions of the interlaced image.

Polarization has significant advantages over color filtering in that it permits the stereoscopic image to be viewed in natural color without the loss of brightness caused by color filtering. Natural color is in general more pleasing to the viewer, while the increased brightness provided by polarization permits the use of lower intensity image sources such as LCD displays of the type used in portable handheld video game players.

In addition, polarization has the advantage that a person wearing polarized lenses can turn away from the interlaced image and view other objects or persons without having to take off the lenses. Since the polarizers and polarizing lenses are transparent, the stereoscopic effect can be created with what appears to the viewer to be ordinary clear lenses, as opposed to the color lenses used in conventional non-polarizing stereoscopic systems.

Despite the well-known advantages of using polarizing filters to distinguish the left and right eye portions of interlaced stereoscopic images, it is currently impossible to use polarization in connection with conventional cathode ray tube or LCD displays because the light emitting pixels of the displays cannot be made to emit polarized light. As a result, unlike stereoscopic displays that use colorization and interlacing before recording or broadcast, stereoscopic displays that use polarization require that polarization be carried out at the viewing location and, in addition, require that interlacing also be carried out at the viewing location since it is virtually impossible to synchronize or align oppositely polarized sheets with the appropriate portions of an image that has been broadcast or recorded in interlaced form. It is not so much the lack of viable polarizers or polarizing filters that has limited the available of polarizing stereoscopic systems, but rather the lack of a practical image interlacing arrangement for interlacing the images following polarization.

By way of background, examples of image interlacing arrangements using relatively complex or expensive optical devices such as beam splitters are disclosed in U.S. Pat. Nos. 5,671,992, 5,993,004, and 5,956,180, while a stereoscopic device utilizing multiple polarizing sheets is disclosed in U.S. Pat. No. 5,973,831. In addition, a number of arrangements have been proposed for electronically synchronizing polarizers with temporally interlaced images, i.e., for switching polarization as the left and right eye images are alternately displayed, but such systems are even more complex than purely optical arrangements.

The one reference that does disclose a relatively simple non-switched stereoscopic system is the above-cited Sheiman patent. The system disclosed in this patent shares with the present invention the principle of using an image interlacing sheet which combines the images following polarization. However, the system as disclosed in the Sheiman patent also possesses a fatal flaw, namely the creation of ghost images above and below, or to the side of, the interlaced left and right eye images.

These ghost images result from the fact that the prisms on the image interlacing sheet must bend light from the separate images in two directions, with the left and right eye images being refracted to the same spatial position. For example, if the left eye image is displayed on the lower half of the display and the right eye image is displayed on the top half of the display, then the left eye image must be refracted upwards and the right eye image must be refracted downwards. However, the same surfaces that refract the left eye image upwards and the right eye image downwards will also have the effect of refracting the left eye image downwards and the right eye image upwards, resulting in the appearance of ghost left and right eye images above and below the combined or interlaced image. This effect is very noticeable in practice, and seriously detracts from the intended stereoscopic effect.

The present invention, on the other hand, provides a simple and convenient solution to the problem of interlacing images at the viewing location, making possible practical stereoscopic devices that use polarization instead of color filtering and yet that are not subject to ghosting, offering a dramatic improvement over the throwaway stereoscopic effects arrangements currently in use, and a practical alternative to the complex optical or opto-electronic systems proposed in previous patents.

### SUMMARY OF THE INVENTION

It is accordingly a first objective of the invention to provide a practical way of optically interlacing separate left eye and right eye portions of a stereoscopic image, so that the separate portions of the image can be more conveniently recorded or broadcast, and subsequently polarized, as separate images, and yet in which ghost images are eliminated.

It is a second objective of the invention to provide arrangements for interlacing images in a stereoscopic imaging system that can be used with a variety of different image sources, including split screens, multiple screens, and combinations of video and static displays or objects.

It is a third objective of the invention to provide a practical arrangement for interlacing oppositely polarized left and right eye images for use in stereoscopic imaging systems and devices.

It is a fourth objective of the invention to provide a device for viewing stereoscopic video images in true color, and yet that can be used with an LCD display.

It is a fifth objective of the invention to provide a simple and inexpensive arrangement for converting an ordinary television or computer monitor into a stereoscopic effects device without the need for modification of the television or computer monitor, without special tools or skills, and which is not subject to ghosting.

These objectives are achieved, in accordance with the principles of various preferred embodiments of the invention, by providing a stereoscopic imaging system and method in which, in a manner similar to that disclosed in the Sheiman patent, left and right eye images are separately transmitted to a display device, polarized following display, and combined following polarization. However, unlike the stereoscopic imaging system disclosed in the Sheiman system, the polarizers and image interlacing sheet are installed in a housing that serves not only to align the polarizers and interlacing sheet, thereby simplifying implementation, but which also serves to provide a masking effect that eliminates the aforementioned ghost images while still affording a relatively wide field of view.

Image interlacing is providing by an especially simple and effective arrangement involving a microprism sheet having one set of surfaces oriented at a first angle corresponding to a position of a first image source, and a second set of surfaces oriented at a second angle corresponding to a position of a second image source so as to interlace the images. By appropriately selecting the position of the images to be interlaced, and therefore the first and second angles, the interlaced image can be made to project into a single plane. If the images are pre-polarized or otherwise differentiated before interlacing, the interlaced images can thus be directly combined to exhibit a three-dimensional stereoscopic effect when viewed directly through corresponding lenses.

The separate images combined or interlaced in the preferred stereoscopic imaging system and method of the invention may be displayed on a split screen, multiple screens arranged horizontally, multiple screens arranged vertically, and may even include images of real objects, as well as images displayed on cathode ray tubes, liquid crystals displays, or any other video or still image displays.

The arrangement of the invention can be used to make an especially simple and yet effective stereoscopic viewing device. Because the invention permits polarization to distinguish left and right eye images, there is less loss of brightness than occurs with color filters, and a relatively dim liquid crystal display can be used as the source of the left and right eye images. The result is a stereoscopic device having a construction that is significantly simpler than the stereoscopic viewing devices or visors of the prior art, which relied on beam splitters or multiple polarizations. Such a stereoscopic device has potential application as a video game player, virtual reality display visor, stand-alone “3D” movie viewer, and so forth.

While especially suitable for use in stereoscopic imaging systems or devices, and in particular those in which the left and right eye portions of a stereoscopic or three-dimensional image are distinguished by opposite polarization, it will be appreciated by those skilled in the art that the image interlacing arrangements of the invention may be used in contexts other than those involving true stereoscopic images, including heads-up displays of various types, closed captioning, or other displays of superimposed images.

In addition to planar microprism sheets disclosed in the parent application, U.S. patent application Ser. No. 09/481,942, it is also possible, according to further embodiments of the present invention, to vary the construction of the microprism sheets by varying the shape of individual facets, or by curving the sheets to change the direction of light transmission. Although potentially useful in the context of image interlacing, it will be appreciated by those skilled in the art that this aspect of the invention may be used in a wide variety of microprism applications, including image focusing and projection arrangements in general.

### BRIEF DESCRIPTION OF THE DRAWINGS

FIG. 1 is a schematic diagram of a prior art stereoscopic imaging arrangement.

FIG. 2 is a schematic diagram illustrating use of a microprism sheet to interlace images according to the principles of a first preferred embodiment of the invention.

FIG. 3 is a schematic diagram showing a handheld stereoscopic device constructed according to the principles of a second preferred embodiment of the invention.

FIG. 4 is a schematic diagram of an image interlacing arrangement according to a third preferred embodiment of the invention.

FIG. 5 is a schematic diagram of an image interlacing arrangement according to a fourth preferred embodiment of the invention.

FIG. 6 is a schematic diagram of an image interlacing arrangement according to a fifth preferred embodiment of the invention.

FIGS. 7A-7C are plan views of modifications of the microprism sheets shown in FIGS. 2-6.

FIG. 8 is an isometric view of a stereoscopic effects device retrofitted onto a conventional television or computer monitor.

FIGS. 9 and 10 are isometric views showing the manner in which the stereoscopic effects device of FIG. 8 may be assembled.

### DETAILED DESCRIPTION OF THE PREFERRED EMBODIMENTS

As illustrated in FIG. 2, a microprism sheet 1 is arranged such that light from a first image 2 is refracted by surfaces 3 and light from a second image 4 is refracted by surfaces 5 so as to exit the microprism sheet in parallel and thereby form a single interlaced image 6. The angles of surfaces 3 and 5 are selected based on the position of the microprism and on the relative positions of the separate images, which originate in this embodiment from a split screen divided vertically, horizontally, or in any other desired manner, so that the separate images, which may correspond to the above-described left eye and right eye images, can easily be polarized by polarizing filters or sheets 7,8 positioned between the image source and the microprism sheet before interlacing for viewing by appropriately polarized lenses 9,10 after interlacing.

It will be appreciated that the facets of the microprism sheet 1 illustrated in FIG. 2 are not drawn to scale. The construction of the microprism sheet may be entirely conventional, utilizing the known construction techniques and materials described in copending U.S. patent application Ser. No. 09/481,942, or the microprism sheet may be modified to include anti-glare, anti-radiation, or other coatings. In addition, according to the principles described in the copending application, the separate polarizers 7 and 8 may even be replaced by polarizing coatings on individual facets of the microprism sheet 1.

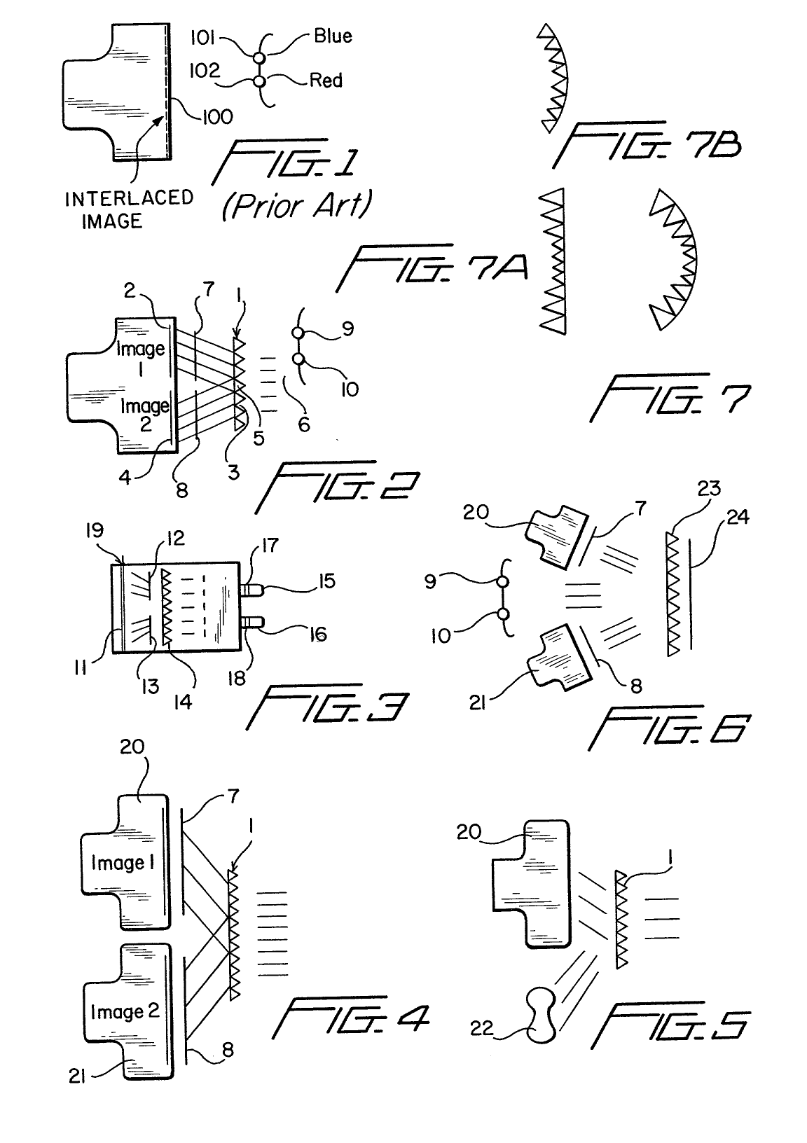

The simple image interlacing arrangement illustrated in FIG. 1 can easily be integrated into stereoscopic effects devices such as the one illustrated in FIG. 3. In this device, the image source is provided by an LCD screen 11, polarization by polarizing sheets 12,13, interlacing by microprism sheet 14, and direction of the appropriate image portions to the left and right eyes of the viewer by eyepieces 15,16 including polarized filters or lenses 17,18, all of which are contained in a housing 19. In addition, it is within the scope of the invention to provide additional optical components (not shown) for the purpose of focusing or guiding light between the illustrated components.

The stereoscopic effects device of this embodiment of the invention can be used as a portable or handheld video game player, or integrated into a variety of other devices such as arcade games, virtual reality visors, aircraft or military training simulators, and any other devices that currently use flat two-dimensional displays, but which might benefit from the addition of stereoscopic effects.

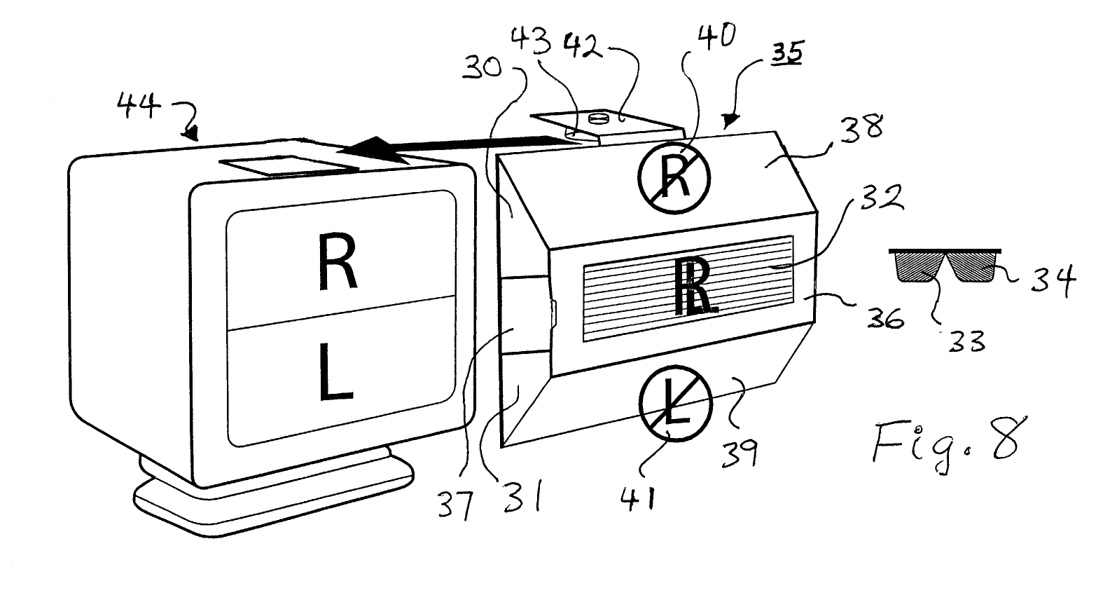

Instead of a single screen image source as illustrated in FIG. 2, the principles of the invention may be extended to cover images that originate on separate screens 20,21, as illustrated in FIG. 4, or arbitrary image sources 22 other than video screens, including real objects, as illustrated in FIG. 5. In addition, by placing a microprism sheet 23 having appropriately shaped facets in front of a mirror 24, or by adding a reflective coating to the back of the sheet, the image interlacing arrangement can possibly be arranged to form an image interlacing projection screen, as illustrated in FIG. 6.

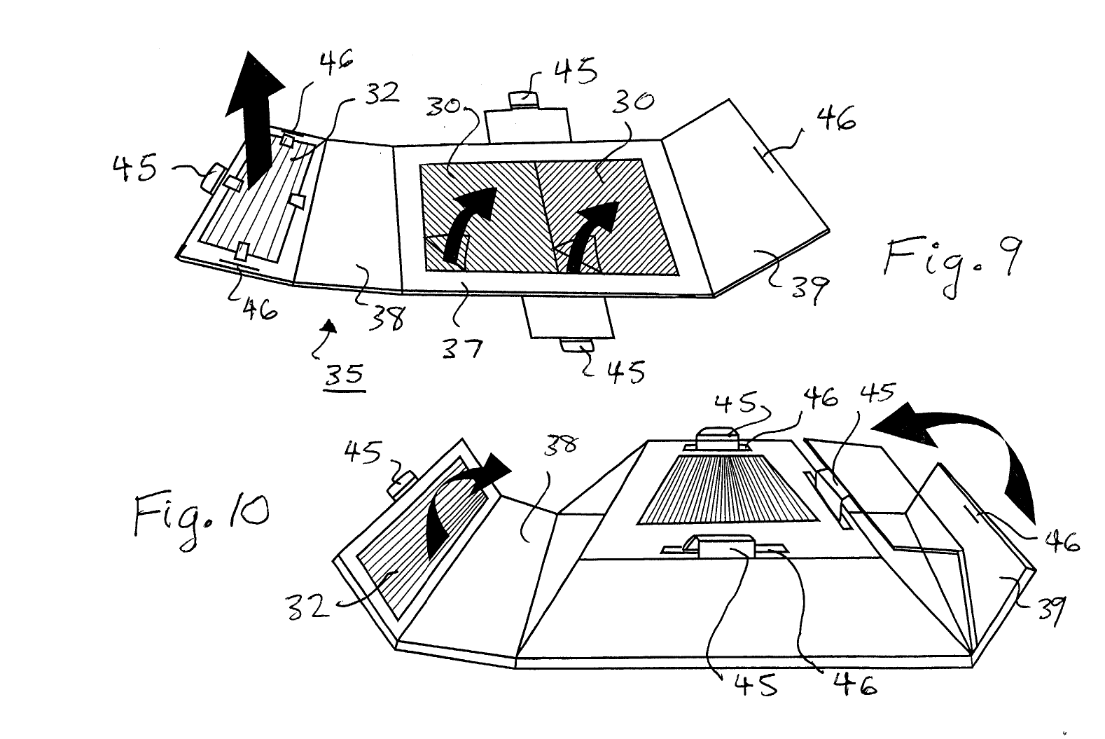

Finally, as illustrated in FIGS. 7A-7C, the microprism sheets used to interlace the images in any of the embodiments of FIGS. 2-4 need not be planar microprism sheets with uniform facets. It is also within the scope of the invention to vary the size of the facets so as to focus or project images transmitted thereby, as illustrated in FIG. 7A, to curve the sheets to achieve similar effects, as illustrated in FIG. 7B, or to combine the concepts of varying the size of the facets and curving the sheets, as illustrated in FIG. 7C.

Although potentially useful in connection with image interlacing applications as described herein, the microprism sheet modifications illustrated in FIGS. 7A-7C may be used in any context in which microprism sheets are conventionally used, and possibly in additional contexts. For example, if the microprism sheet of FIG. 7B is formed in a parabola shape, the microprism sheet can be used as a convenient focusing lens or collimator.

FIG. 8 illustrates an especially practical stereoscopic effects device capable of implementing the principles of the invention. The stereoscopic effects device of FIG. 8 includes a pair of polarizers 30 and 31 corresponding to polarizers 7 and 8 illustrated in FIG. 2, a microprism sheet 32 corresponding to microprism sheet 1 illustrated in FIG. 2, and at least one pair of polarized lenses 33,34 corresponding to polarized lenses 9,10 described above in connection with FIG. 2. Polarizers 30,31 and microprism sheet 32 are attached to a housing/mask structure 35 including front panel 36 to which the microprism sheet 32 is attached, rear panel 37 including the two polarizers 30,31, and opaque masking sections 38,39 arranged to prevent the appearance of ghost images 40,41.

The housing/mask structure 35 further includes an attachment section 42 extending therefrom including a suction cup 43 to enable structure 35 to be removably secured to a television, computer monitor, or other display device 44. Although, in the illustrated embodiment, the attachment section includes a suction cup, it will be appreciated by those skilled in the art that the specific means by which the stereoscopic effects device is secured to the television, computer monitor, or other display device may be varied in numerous ways, and may include, by way of example and not limitation, mechanical attachment structures such as tabs or hooks arranged to engage corresponding slots, adhesive structures, and so forth.

Furthermore, although masking sections 38 and 39 are illustrated as being inclined relative to front panel 36 and rear panel 37, it will be appreciated by those skilled in the art that the orientation and configuration of masking sections 38 and 39 may be varied without affecting performance of the stereoscopic effects device so long as the mask sections are situated in at the locations where the ghost images would otherwise appear were the microprism sheet to extend the full width or height of the television or computer monitor display screen. So long as structure 35 supports polarizers 30,31 and microprism sheet 32, and provides masking in the area of ghost images 40,41, the materials, shape, and construction of structure 35 may be freely selected to take into considerations of convenience, cost, and aesthetics.

By way of illustration, structure 35 may be constructed of an inexpensive foldable material such as cardboard or PVC, and may include tabs 45 and slots 46 so as to enable assembly by a user in the manner illustrated in FIGS. 9 and 10. Alternatively, the structure 35 may of course be pre-assembled, molded in a single piece, integrally formed with the television or computer monitor, and so forth.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention. Accordingly, it is intended that the invention not be limited by the above description or accompanying drawings, but that it be defined solely in accordance with the appended claims.

What is claimed is:

1. A stereoscopic imaging system, comprising:
a display arranged to display separate images, one representing a right eye portion of a stereoscopic image, and the other representing a left eye portion of the stereoscopic image;
polarizers arranged to oppositely polarize the left and right eye images;
an image interlacing arrangement for combining the oppositely polarized left eye and right eye images;
polarizing filters for enabling respective right and left eyes of a person to view the corresponding oppositely polarized and interlaced left and right eye images; and
a mask arranged to prevent the person from viewing ghosts of the left and right eye images.

2. A stereoscopic imaging system as claimed in claim 1, wherein the image interlacing arrangement includes:
a microprism sheet including a substrate and a plurality of grooves having intersecting sides that form a v-shape, the sides of the grooves forming first and second sets of substantially planar surfaces,
wherein said sides of the grooves are respectively arranged to refract light from first and second image sources so that said light from said first and second image sources exits said microprism sheet in parallel to form an interlaced image.

3. A stereoscopic imaging system as claimed in claim 1, wherein said first and second image sources are separate regions of a single image display screen.

4. A stereoscopic imaging system as claimed in claim 1, wherein said image interlacing arrangement, polarizers, and mask are housed in a single structure arranged to be removably attached to a television or computer monitor in order to enable viewing of stereoscopic images on said display through said polarizing filters.

5. A stereoscopic imaging system as claimed in claim 4, wherein said polarizing filters are housed in eyeglasses.

6. A stereoscopic effects device, comprising:
an image interlacing arrangement including
at least one video display screen;
a microprism sheet including a substrate and a plurality of grooves having intersecting sides that form a v-shape, the sides of the grooves forming first and second sets of substantially planar surfaces,
wherein said sides of the grooves are respectively arranged to refract light from first and second image sources so that said light from separate first and second images on said video display screen exits said microprism sheet in parallel to form an interlaced image;
polarizers situated between said video display screen and said microprism sheet; and
polarized filters situated between said microprism sheet and respective left and right eyes of a person, wherein said microprism sheet and polarizers are housed in a common housing.

7. A stereoscopic effects device as claimed in claim 6, wherein said housing is a housing of a handheld video game player.

8. A stereoscopic effects device as claimed in claim 7, wherein said video display screen is an LCD screen.

9. A stereoscopic effects device as claimed in claim 6, wherein said video display screen is an LCD screen.

10. A stereoscopic effects device as claimed in claim 6, wherein said common housing is arranged to be removably attached to a front of a television or computer monitor.

11. A stereoscopic effects device as claimed in claim 10, wherein said polarizing filters are separately housed in eyeglasses.

12. A stereoscopic imaging method, comprising the steps of:
displaying separate images, one representing a right eye portion of a stereoscopic image, and the other representing a left eye portion of the stereoscopic image;
oppositely polarizing the left and right eye images;
combining the oppositely polarized left eye and right eye images;
masking the oppositely polarized and interlaced left and right eye images to eliminate ghosts; and
using polarizing filters to enabling respective right and left eyes of a person to view the corresponding oppositely polarized and interlaced left and right eye images.

13. A stereoscopic imaging method as claimed in claim 12,
wherein the step of combining the images comprises the step of interlacing the images using an image interlacing arrangement that includes:
a microprism sheet including a substrate and a plurality of grooves having intersecting sides that form a v-shape, the sides of the grooves forming first and second sets of substantially planar surfaces,
wherein said sides of the grooves are respectively arranged to refract light from first and second image sources so that said light from said first and second image sources exits said microprism sheet in parallel to form an interlaced image.
